(19) United States
(12) Patent Application Publication
(10) Pub. No.: US 2025/0196124 A1
(43) Pub. Date: Jun. 19, 2025

(54) Methods, Systems, and Devices for Capillary Pipetting

(71) Applicant: IDEXX Laboratories, Inc., Westbrook, ME (US)

(72) Inventors: David Connolly, Westbrook, ME (US); Richard Andrews, Westbrook, ME (US)

(21) Appl. No.: 18/933,928

(22) Filed: Oct. 31, 2024

Related U.S. Application Data
(60) Provisional application No. 63/612,070, filed on Dec. 19, 2023.

(51) Int. Cl. B01L 3/02

(52) U.S. Cl. CPC B01L 3/021; B01L 2200/12; B01L 2300/0832; B01L 2300/12; B01L 2400/0406; B01L 2400/0481

(57) ABSTRACT

A blood transfer device is disclosed. The blood transfer device includes a pipette comprising a bulb portion, wherein the bulb portion comprises a compressible wall and an aperture extending through the compressible wall and an end portion opposite the bulb portion, wherein the end portion comprises an insertion portion, and wherein the end portion is in fluid communication with the bulb portion. The blood transfer device further includes a capillary tube, wherein the capillary tube is positioned at least partially within the end portion and extends at least partially beyond the insertion portion.

### CROSS-REFERENCE TO RELATED APPLICATIONS

This application claims the benefit of co-pending U.S. Provisional Patent Application Ser. No. 63/612,070, filed Dec. 19, 2023 which is hereby incorporated by reference in its entirety.

### FIELD OF THE DISCLOSURE

The present disclosure involves methods, systems, and devices for withdrawing and dispensing a liquid biological sample (e.g., blood), and methods for using and manufacturing the devices and systems thereof. Namely, devices, systems, and methods of the present disclosure involve a capillary pipetting device for withdrawing, transporting, and dispensing blood.

### SUMMARY

In an example, a blood transfer device is disclosed. The blood transfer device includes a pipette comprising a bulb portion, wherein the bulb portion comprises a compressible wall and an aperture extending through the compressible wall and an end portion opposite the bulb portion, wherein the end portion comprises an insertion portion, and wherein the end portion is in fluid communication with the bulb portion. In a further aspect, the blood transfer device includes a capillary tube, wherein the capillary tube is positioned at least partially within the end portion and extends at least partially beyond the insertion portion.

In another example, a method for transferring blood from a vessel containing blood to a container is disclosed. The method includes inserting a capillary tube of a blood transfer device into the vessel containing blood, wherein the blood transfer device further comprises a pipette comprising: (i) a bulb portion, wherein the bulb portion comprises a compressible wall and an aperture extending through the compressible wall; and (ii) an end portion opposite the bulb portion, wherein the end portion comprises an insertion portion, and wherein the end portion is in fluid communication with the bulb portion, and wherein the capillary tube is positioned at least partially within the end portion and extends at least partially beyond the insertion portion. The method additionally includes drawing blood from the vessel into the capillary tube. The method further includes covering the aperture. The method additionally includes while covering the aperture, removing the blood transfer device from the vessel. The method further includes, while covering the aperture, compressing, via the compressible wall, at least one of the bulb portion and the reservoir portion of the pipette, thereby transferring blood from the capillary tube to the container.

In another example, a method for manufacturing a blood transfer device is disclosed. The method includes inserting a capillary tube into an insertion portion of a pipette comprising: (i) a bulb portion, wherein the bulb portion comprises a compressible wall and an aperture extending through the compressible wall; and (ii) an end portion opposite the bulb portion, wherein the end portion comprises an insertion portion, and wherein the end portion is in fluid communication with the bulb portion, and, after insertion, the capillary tube is positioned at least partially within the end portion and extends at least partially beyond the insertion portion.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1A illustrates an example blood transfer device, according to an example embodiment.

FIG. 1B illustrates the example blood transfer device of FIG. 1A operating in an example environment, according to an example embodiment.

FIG. 1C illustrates the example blood transfer device of FIGS. 1A-B operating in an example environment, according to an example embodiment.

FIG. 1D illustrates the example blood transfer device of FIGS. 1A-1C, according to an example embodiment.

FIG. 2 illustrates a method, according to an example embodiment.

FIG. 3 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Generally, devices and systems described herein include a liquid transfer device containing a liquid biological sample (e.g., blood). In example embodiments, different configurations and materials can have advantages depending on the type and amount of biological sample being tested. For instance, withdrawing, transporting, and dispensing blood is rife with challenges. For example, blood becomes more viscous and unworkable as a fluid when it is exposed to environment conditions (e.g., oxygen) and/or surfaces (e.g., pipettes, test tubes)-often due to hemolysis. And, as time elapses and/or multiple exposures are compounded, these challenges are only heightened. Thus, there exists a need for methods, systems, and devices for withdrawing, transporting, and dispensing blood in a swift, reliable, and consistent manner.

Within examples, the present disclosure is directed to methods, systems, and devices for withdrawing and dispensing a liquid biological sample (e.g., blood), and methods for manufacturing the devices and systems thereof. Namely, devices, systems, and methods of the present disclosure involve a capillary pipetting device for withdrawing, transporting, and dispensing blood in a swift, consistent manner that is the repeatable from user to user.

An example blood transfer device, according to devices and systems disclosed herein, includes a pipette comprising a bulb portion. In some examples, the bulb portion comprises a compressible wall and an aperture extending through the compressible wall. In some examples, the pipette and/or or one or more portions of the pipette (e.g., the compressible wall, the bulb portion) comprise one or more of the following compressible materials: (i) polybutylene terephthalate (PBT); (ii) polyethylene terephthalate (PET); (iii) thermoplastic elastomer (TPE); (iv) silicone; (v) natural rubber; and (vi) synthetic rubber. In examples, the bulb portion and/or one or more portions thereof may take one or more shapes, including a cylindrical shape, a spherical shape, a semi-spherical shape, a square shape, a rectangular shape, a conical shape, and/or a semi-rounded shape, among other possibilities.

In example embodiments, the pipette of the example blood transfer device also includes an end portion opposite the bulb portion. In examples, this end portion includes an insertion portion where one or more devices may be inserted. In some examples, the insertion portion may take one or more forms and may even be used for multiple purposes. For example, the end portion and/or the insertion portion may take one or more shapes, including a cylindrical shape, a spherical shape, a semi-spherical shape, a square shape, a rectangular shape, a conical shape, and/or a semi-rounded shape, among other possibilities. In some examples, the end portion comprises one or more of the following compressible materials: (i) polybutylene terephthalate (PBT); (ii) polyethylene terephthalate (PET); (iii) thermoplastic elastomer (TPE); (iv) silicone; (v) natural rubber; and (vi) synthetic rubber.

In a further aspect, in some examples, the end portion may have a diameter that is less than a diameter of one or more of (i) the end portion; and (ii) the bulb portion. In other examples, the end portion may be in fluid communication with the bulb portion in order to transport a fluid from the bulb portion to one or more portions of the end portion, transport a fluid from the end portion to one or more portions of the bulb portion, or both, among other possibilities.

In some examples, the insertion portion may be configured to receive one or more objects into the insertion portion, including a capillary tube.

In some examples, the example blood transfer device also includes a capillary tube inserted into the insertion portion of the pipette. In some examples, the capillary tube is positioned at least partially within the end portion (e.g., in an area extending toward the bulb portion) and extends at least partially beyond the insertion portion (e.g., outwardly beyond the insertion portion). In some examples, the capillary tube and/or or one or more portions thereof comprise one or more of the following materials: (i) glass; (ii) metal; (iii) metal alloy; and (iv) plastic.

In example embodiments, the capillary tube may be in fluid communication with the pipette (e.g., the bulb portion and/or the end portion) in order to transport a fluid from one or more components of the pipette to one or more portions of the capillary tube, transport a fluid from one or more components of the capillary tube to one or more portions, of the pipette or both, among other possibilities. In some example embodiments, the capillary tube may take one or more shapes, including a cylindrical shape, a semi-cylindrical shape, a square shape, a rectangular shape, a conical shape, and/or a semi-rounded shape, among other possibilities. In a further aspect, in examples, the capillary tube may comprise a particular interior volume, including: 1 μl, 3 μl, 5 μl, 10 μl, 11 μl, 12 μl, 13 μl, 14 μl, 15 μl, 16 μl, 17 μl, 18 μl, 19 μl, 20 μl, 21 μl, 22 μl, 23 μl, 24 μl, 25 μl, 26 μl, 27 μl, 28 μl, 29 μl, 30 μl, 40 μl, 50 μl, 60 μl, and 70 μl, among other possibilities. For example, the capillary tube may comprise an interior volume between 18 and 22 μl. In an example embodiment, the capillary tube may comprise an interior volume of 20 μl. Other examples are possible.

In some examples, the one or more components of the blood transfer device will be of a particular length and/or relative dimensions, both compared to themselves and other components of the blood transfer device. For example, in some embodiments, the length of the pipette is approximately 86 mm and, after the majority of the capillary tube is inserted into the insertion portion, the length of the capillary tube that extends outwardly beyond the end portion is approximately 5 mm. In this embodiment, the total length of the blood transfer device will be approximately 91 mm. In other examples, the pipette length may be various lengths, including: 50 mm, 55 mm, 60 mm, 65 mm, 70 mm, 75 mm, 80 mm, 85 mm, 87 mm, 88 mm, 89 mm, 90 mm, 95 mm, 105 mm, 110 mm, and 115 mm, among other possibilities. For example, in some embodiments, after the capillary tube is inserted into the insertion portion, the length of the capillary tube that extends outwardly beyond the end portion may be various lengths, including approximately.5 mm, 1 mm, 2 mm, 3 mm, 4 mm, 4.5 mm, 5.5 mm, 6 mm, 7 mm, 8 mm, 9 mm, 10 mm, and 11 mm, among other possibilities. Other examples are possible.

For example, in some embodiments, the diameter of the aperture is less than the diameter of the insertion portion. In some examples, the diameter of the aperture is greater than the diameter of the insertion portion. In some examples, the diameter of the aperture is approximately the same as the diameter of the insertion portion. Other examples are possible.

For example, in some embodiments, the pipette of the blood transfer device further comprises a reservoir portion. In some embodiments, the reservoir portion is disposed between the bulb portion and the end portion and is configured to hold the biological fluid sample (e.g., blood). In some examples, the reservoir portion is also in fluid communication with the bulb portion and the end portion and may include a compressible wall. In some examples, the reservoir portion and/or or one or more portions of the reservoir portion comprise one or more of the following compressible materials: (i) polybutylene terephthalate (PBT); (ii) polyethylene terephthalate (PET); (iii) thermoplastic elastomer (TPE); (iv) silicone; (v) natural rubber; and (vi) synthetic rubber. In examples, the reservoir portion and/or one or more portions thereof may take one or more shapes, including a cylindrical shape, a spherical shape, a semi-spherical shape, a square shape, a rectangular shape, a conical shape, and/or a semi-rounded shape, among other possibilities.

Methods of using and/or manufacturing (or otherwise assembling) of the blood transfer devices disclosed herein allow for a variety of sizes of components and configurations to be utilized to provide fast and reliable blood withdrawing, transporting, and dispensing events. Further, by utilizing the same or similar components to assemble blood transfer devices that can be used in a variety of use cases, assembly automation and reduced production time and cost may be realized. The example blood transfer devices and methods described herein also improve precision and consistency of one or more parameters of the blood transfer device, including consistent blood volumes withdrawn due to one or more design features of the blood transfer device, including the heights and dimensions of the capillary tube, the insertion depth of the capillary tube into the insertion portion of the pipette, the amount of capillary tube that extends within the end portion, the amount of capillary tube that extends beyond the insertion portion, and/or the size, shape, number, and placement of one or more apertures, among other possibilities. These improvements may lead to improved withdrawing, transportation, and/or dispensing events, any or all of which will lead to improved imaging techniques and diagnostic results (e.g., assay results), alike.

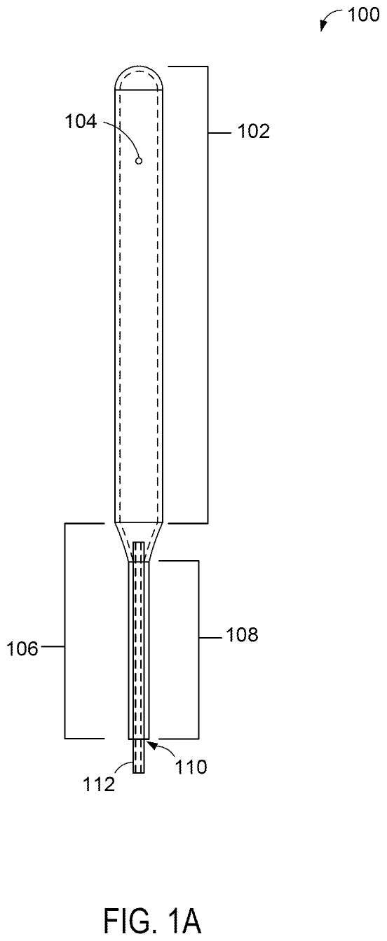

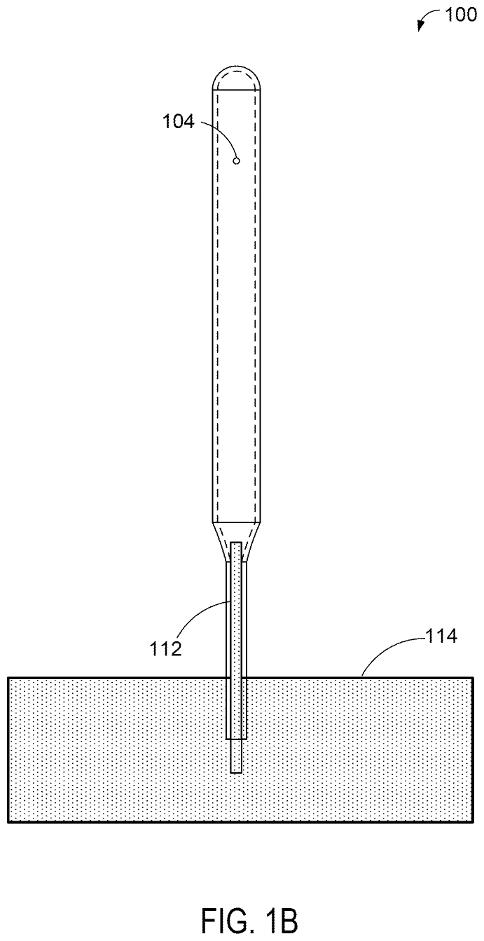

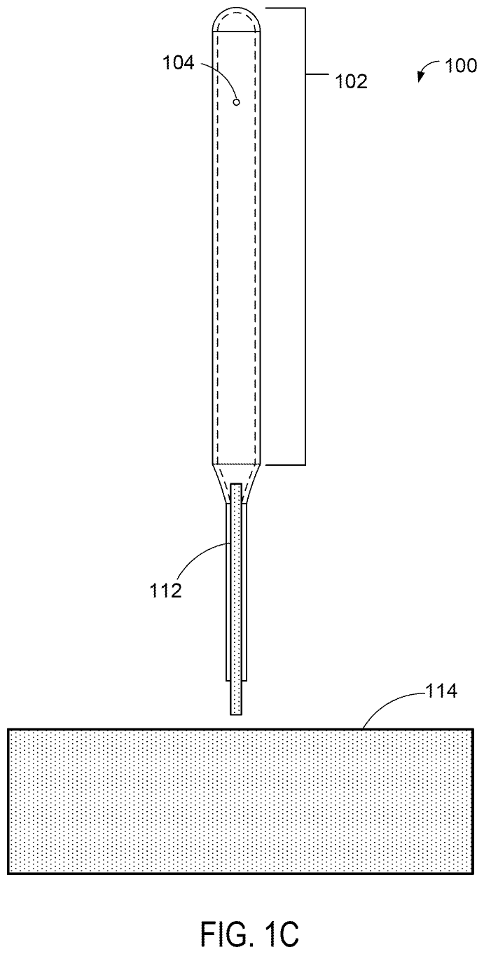

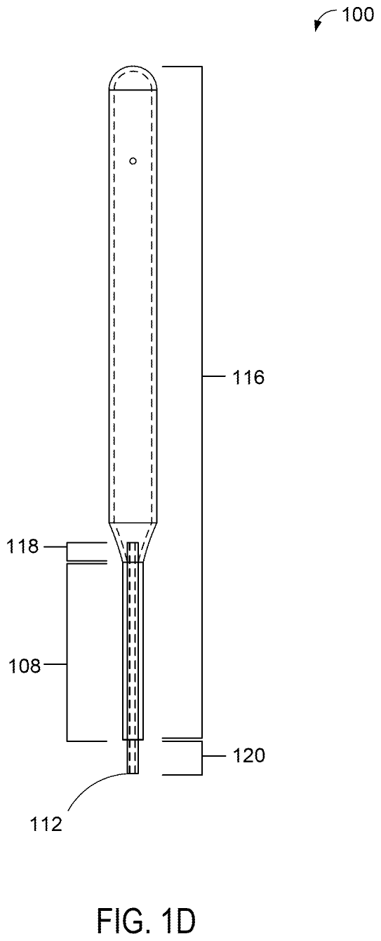

Referring now to FIGS. 1A-1D which illustrate example components, dimensions, and configurations of an example blood transfer device after assembly and, in some examples, operating in an example environment.

Now referring to FIG. 1A, which illustrates an example blood transfer device 100, which includes a bulb portion 102, aperture 104, end portion 106 (which includes insertion portion 108 and opening 110), and capillary tube 112, according to an example embodiment. As shown in FIG. 1A, capillary tube 112 has been inserted into the insertion portion 108 of end portion 106 via opening 110, and portions of the capillary tube extend within the top portion of the end portion 106, as well as beyond the insertion portion 108. According to example embodiments, FIG. 1A represents the assembled view of example blood transfer device 100. Many example configurations are possible.

Now referring to FIG. 1B, the tip of blood transfer device 100 can be inserted into a vessel 114 of blood, or a vessel or any other suitable liquid. By doing so, and not covering aperture 104, as illustrated in FIG. 1B, the blood from vessel 114 has drawn up capillary tube 112. In examples, the blood may draw up into the capillary tube 112 based on one or more parameters of the capillary tube, including the inner diameter of capillary tube 112, the material of capillary tube 112, and/or one or more physical characteristics of the capillary tube 112 (e.g., temperature) compared to the blood and/or the vessel in which the blood is disposed. This type of movement and/or drawing of the blood into the capillary tube 112 is often referred to as “sorptivity” or “capillary suction.” In other examples, one or more actions may be performed on one or more components of the example blood transfer device to assist in drawing the blood up into the capillary tube 112, including suction from the bulb portion 102 (e.g., via aperture 104).

Furthermore, although the blood transfer device 100 is illustrated as being inserted in vessel 114 at angle that is normal (90 degrees) to the surface of the vessel, blood transfer device 100 may be inserted into vessel 114 at one or more additional or alternative angles to the surface of the vessel to further facilitate the blood being drawn up into the capillary tube 112, including 10 degrees, 15 degrees, 20 degrees, 25 degrees, 30 degrees, 35 degrees, 40 degrees, 45 degrees, 50degrees, 55 degrees, 60 degrees, 65 degrees, 70 degrees, 75 degrees, 80 degrees, 85 degrees, and/or 87.5 degrees, among other possibilities. As illustrated in FIG. 1B, once the blood draws up and fills the capillary tube 112, the aperture 104 may be covered to retain the blood in the capillary tube 112 during transport and before dispersion.

Now referring to FIG. 1C, the tip of the example blood transfer device 100 has been removed from vessel 114, and because the aperture 104 is covered, the blood from vessel 114 remains drawn up in capillary tube 112. In examples, to dispense the blood in capillary tube 112, aperture may be uncovered and the blood may be allowed to slowly drip out over a period of time. However, to assist in dispensing the blood, in examples, bulb portion 102 may be made of one or more compressible materials (e.g., a compressible wall made of PBT or PET) and, while the aperture is covered, the bulb portion may be compressed to create an outward pressure on the blood in the capillary tube 112 to dispense the blood more quickly. based on one or more parameters of the capillary tube, including the inner diameter of capillary tube 112, the material of capillary tube 112, and/or one or more physical characteristics of the capillary tube 112 (e.g., temperature) compared to the blood and/or the vessel in which the blood is disposed. Other examples are possible.

Furthermore, in example embodiments, the blood may be dispersed into one or more containers (e.g., for imaging and/or other types of analysis). In some examples, this container may include one or more slides. In some embodiments, this container may include one or more cartridges. In example embodiments, these slides and/or cartridges can be used for a variety of tests. For instance, these tests may include imaging of one or more of the following: (i) blood; (ii) urine; (iii) saliva; (iv) fecal matter; (v) secretion; (vi) excretion; (vii) FNA; (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites, among other possibilities. Test may additionally include one or more of the following: blood coagulation test, polymerase chain reaction (PCR) test, and/or immunoassay, among other possibilities. For example, in some example embodiments, these tests may include one or more of the following blood chemistry tests: SDMA, Total T4 (TT4), Bile Acids, C-reactive Protein (CRP), Progesterone, Fructosamine, and/or Phenobarbital (PHBR), among other possibilities. For example, in some example embodiments, these tests may include one or more of the following blood chemistry profile tests that measure one or more of the following: ALB, ALB/GLOB, ALKP, ALT, AMYL, AST, BUN, BUN/CREA, Ca, CHOL, CK, CI, CREA, CRP, FRU, GGT, GLOB, GLU, K, LAC, LDH, LIPA, Mg, Na, NH₃, PHOS, TBIL, TP, TRIG and/or URIC, among other possibilities. Other examples are possible.

Now referring to FIG. 1D, which illustrates example dimensions of an example blood transfer device 100 according to an example embodiment. As shown in FIG. 1D, pipette 116 has had capillary tube 112 inserted into the insertion portion 108 of the pipette such a first portion of the capillary tube 112 extends a first length 118 within the top portion of the end portion of the pipette 116, as well as a second length 120 beyond the insertion portion 108. According to example embodiments, FIG. 1D represents a configuration of example blood transfer device 100 where the length of the pipette 116 is approximately 86 mm and, after the majority of the capillary tube is inserted into the insertion portion 108, the second length 120 of the capillary tube that extends outwardly beyond the end portion is approximately 5 mm. In this embodiment, the total length of the blood transfer device will be approximately 91 mm. Many other example configurations are possible.

### Example Methods and Aspects

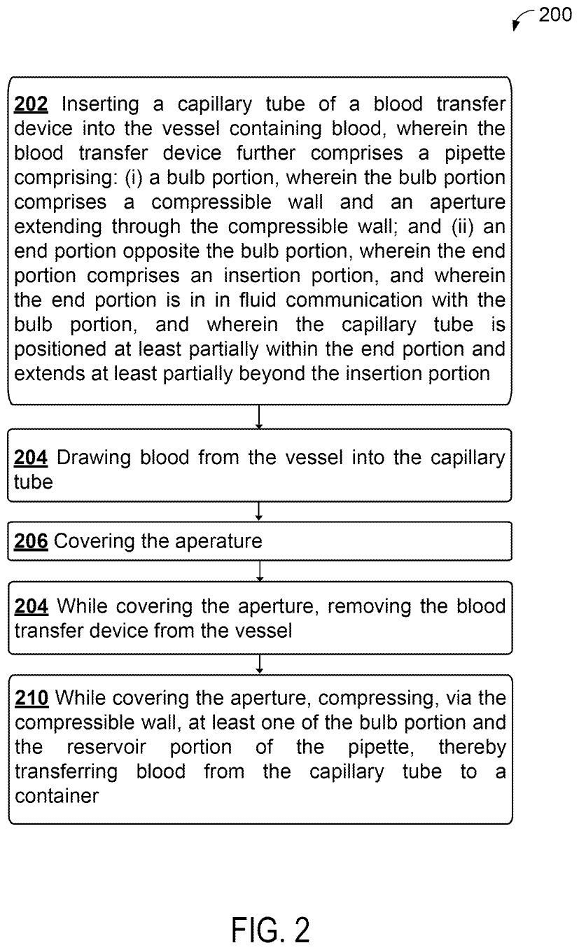

Now referring to FIG. 2, an example method of an example method of using an example blood transfer device is illustrated. Method 200 shown in FIG. 2 presents an example of a method for using an example blood transfer device in FIGS. 1A-1D, for example. Further, devices or systems may be used or configured to perform shown and/or otherwise described in logical functions presented in FIG. 2. In other examples, components of the devices and/or systems may be arranged to be adapted to, capable of, or suited for performing the functions, such as when operated in a specific manner. Method 200 may include one or more operations, functions, or actions as illustrated by one or more of blocks 202. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 202, method 200 involves inserting a capillary tube of a blood transfer device into a vessel containing blood, wherein the blood transfer device further comprises a pipette comprising: (i) a bulb portion, wherein the bulb portion comprises a compressible wall and an aperture extending through the compressible wall; and (ii) an end portion opposite the bulb portion, wherein the end portion comprises an insertion portion, and wherein the end portion is in in fluid communication with the bulb portion, and wherein the capillary tube is positioned at least partially within the end portion and extends at least partially beyond the insertion portion.

In some examples, the capillary tube comprises an interior volume between approximately 18 μl and 22 μl. In some examples, the capillary tube extends outwardly beyond the insertion portion and the capillary tube is in in fluid communication with the end portion. In some examples, a length of the pipette is approximately 86 mm and a length of the capillary tube that extends outwardly from the end portion is approximately 5 mm.

In some examples, a diameter of the insertion portion is less than a diameter of one or more of (i) the end portion; and (ii) the bulb portion. In some examples, a diameter of the aperture is less than a diameter of the insertion portion.

In some examples, the pipette comprises one or more of the following: (i) polybutylene terephthalate (PBT); (ii) polyethylene terephthalate (PET); (iii) thermoplastic elastomer (TPE); (iv) silicone; (v) natural rubber; and (vi) synthetic rubber. In some examples, the capillary tube comprises one or more of the following: (i) glass; (ii) metal; (iii) metal alloy; and (iv) plastic.

In some examples, the container is a cartridge and the cartridge comprises a blood chamber defining a first height and a second height different from the first height.

At block 204, method 200 involves drawing blood from the vessel into the capillary tube.

At block 206, method 200 involves covering the aperture.

At block 208, method 200 involves, while covering the aperture, removing the blood transfer device from the vessel.

At block 210, method 200 involves while covering the aperture, compressing, via the compressible wall, thereby transferring blood from the capillary tube to the container.

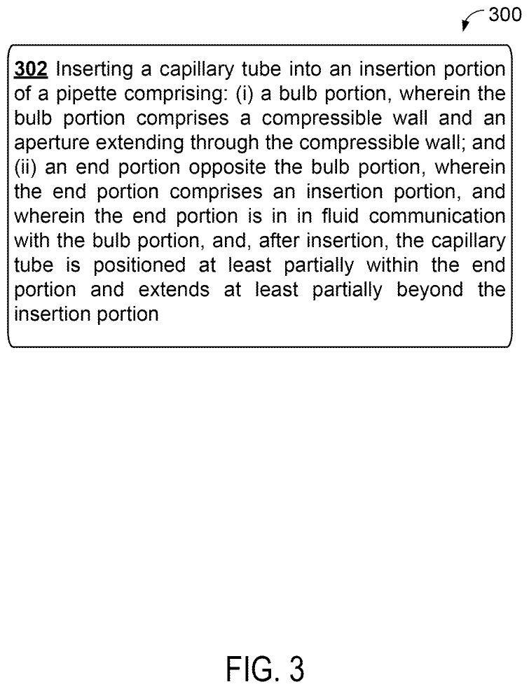

Now referring to FIG. 3, an example method of manufacturing and/or assembling an example blood transfer device is illustrated. Method 300 shown in FIG. 3 presents an example of a method for manufacturing an example blood transfer device in FIGS. 1A-2, for example. Further, devices or systems may be used or configured to perform shown and/or otherwise described in logical functions presented in FIG. 2. In other examples, components of the devices and/or systems may be arranged to be adapted to, capable of, or suited for performing the functions, such as when operated in a specific manner. Method 300 may include one or more operations, functions, or actions as illustrated by one or more of blocks 302. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 302, method 300 involves inserting a capillary tube into an insertion portion of a pipette comprising: (i) a bulb portion, wherein the bulb portion comprises a compressible wall and an aperture extending through the compressible wall; and (ii) an end portion opposite the bulb portion, wherein the end portion comprises an insertion portion, and wherein the end portion is in in fluid communication with the bulb portion, and, after insertion, the capillary tube is positioned at least partially within the end portion and extends at least partially beyond the insertion portion.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A blood transfer device comprising:
a pipette comprising:
a bulb portion, wherein the bulb portion comprises a compressible wall and an aperture extending through the compressible wall; and
an end portion opposite the bulb portion, wherein the end portion comprises an insertion portion, and wherein the end portion is in fluid communication with the bulb portion; and
a capillary tube, wherein the capillary tube is positioned at least partially within the end portion and extends at least partially beyond the insertion portion.

2. The blood transfer device of claim 1, wherein the capillary tube comprises an interior volume between approximately 18 μl and 22 μl.

3. The blood transfer device of claim 2, wherein the capillary tube extends outwardly beyond the insertion portion.

4. The blood transfer device of claim 3, wherein the capillary tube is in fluid communication with the end portion.

5. The blood transfer device of claim 4, wherein a length of the pipette is approximately 86 mm and a length of the capillary tube that extends outwardly beyond the end portion is approximately 5 mm.

6. The blood transfer device of claim 1, wherein a diameter of the insertion portion is less than a diameter of one or more of (i) the end portion; and (ii) the bulb portion.

7. The blood transfer device of claim 1, wherein a diameter of the aperture is less than a diameter of the insertion portion.

8. The blood transfer device of claim 1, wherein the pipette comprises one or more of the following: (i) polybutylene terephthalate (PBT); (ii) polyethylene terephthalate (PET); (iii) thermoplastic elastomer (TPE); (iv) silicone; (v) natural rubber; and (vi) synthetic rubber.

9. The blood transfer device of claim 1, wherein the capillary tube comprises one or more of the following: (i) glass; (ii) metal; (iii) metal alloy; and (iv) plastic.

10. The blood transfer device of claim 1, wherein the pipette further comprises a reservoir portion, and wherein the reservoir portion is disposed between the bulb portion and the end portion, and wherein the reservoir portion is in fluid communication with the bulb portion and the end portion.

11. A method for transferring blood from a vessel containing blood to a container,
wherein the method comprises:
inserting a capillary tube of a blood transfer device into the vessel containing blood, wherein the blood transfer device further comprises a pipette comprising: (i) a bulb portion, wherein the bulb portion comprises a compressible wall and an aperture extending through the compressible wall; and (ii) an end portion opposite the bulb portion, wherein the end portion comprises an insertion portion, and wherein the end portion is in fluid communication with the bulb portion, and wherein the capillary tube is positioned at least partially within the end portion and extends at least partially beyond the insertion portion;
drawing blood from the vessel into the capillary tube;
covering the aperture;
while covering the aperture, removing the blood transfer device from the vessel; and
while covering the aperture, compressing, via the compressible wall, thereby transferring blood from the capillary tube to the container.

12. The method of claim 11, wherein the capillary tube comprises an interior volume between approximately 18 μl and 22 μl.

13. The method of claim 12, wherein the capillary tube extends outwardly beyond the insertion portion, and wherein the capillary tube is in fluid communication with the end portion.

14. The method of claim 13, wherein a length of the pipette is approximately 86 mm and a length of the capillary tube that extends outwardly beyond the end portion is approximately 5 mm.

15. The method of claim 11, wherein a diameter of the insertion portion is less than a diameter of one or more of (i) the end portion; and (ii) the bulb portion.

16. The method of claim 11, wherein a diameter of the aperture is less than a diameter of the insertion portion.

17. The method of claim 11, wherein the pipette comprises one or more of the following: (i) polybutylene terephthalate (PBT); (ii) polyethylene terephthalate (PET); (iii) thermoplastic elastomer (TPE); (iv) silicone; (v) natural rubber; and (vi) synthetic rubber.

18. The method of claim 11, wherein the capillary tube comprises one or more of the following: (i) glass; (ii) metal; (iii) metal alloy; and (iv) plastic.

19. The method of claim 11, wherein the container is a cartridge, and wherein cartridge comprises a blood chamber defining a first height and a second height different from the first height.

20. A method for manufacturing a blood transfer device, the method comprising:
inserting a capillary tube into an insertion portion of a pipette comprising: (i) a bulb portion, wherein the bulb portion comprises a compressible wall and an aperture extending through the compressible wall; and (ii) an end portion opposite the bulb portion, wherein the end portion comprises an insertion portion, and wherein the end portion is in fluid communication with the bulb portion, and, after insertion, the capillary tube is positioned at least partially within the end portion and extends at least partially beyond the insertion portion.
